(19) United States
(12) Patent Application Publication
(10) Pub. No.: US 2005/0108509 A1
(43) Pub. Date: May 19, 2005

(54) Error detection method and system for processors that employs lockstepped concurrent threads

(76) Inventors: Kevin D. Safford, Fort Collins, CO (US); Donald C. Soltis JR., Fort Collins, CO (US); Stephen R. Undy, Fort Collins, CO (US); James D. Gibson, Loveland, CO (US); Eric R. Delano, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/714,093

(22) Filed: Nov. 13, 2003

(51) Int. Cl. G06F 15/00

(52) U.S. Cl. 712/215

(57) ABSTRACT

A processor that includes an in-order execution architecture for executing at least two instructions per cycle (e.g., 2n instructions are processed per cycle, where n is an integer greater than or equal to one) and at least two symmetric execution units. The processor includes an instruction fetch unit for fetching n instructions (where n is an integer greater than or equal to one) and an instruction decoder for decoding the n instruction. The error detection mechanism includes duplication hardware for duplicating the n instructions into a first bundle of n instructions and a second bundle of n instructions. A first execution unit for executing the first bundle of instructions in a first execution cycle, and a second symmetric execution unit for executing the second bundle of instructions in the first execution cycle are provided. The error detection mechanism also includes comparison hardware for comparing the results of the first execution unit and the results of the second execution unit. The comparison hardware can have an exception unit for generating an exception (e.g., raising a fault) when the results are not the same. A commit unit is provided for committing one of the results when the results are the same.

### FIELD OF THE INVENTION

The present invention relates generally to detecting errors in processors, and more particularly, to an error detection method and system for processors that employs lockstepped concurrent threads.

### BACKGROUND OF THE INVENTION

Silicon devices (e.g., microprocessor chips) are increasingly susceptible to “soft errors.” Soft errors are those errors caused by cosmic rays or alpha particle strikes. When these events occur, they cause an arbitrary node within the device (e.g., microprocessor) to change state. Unfortunately, these errors are transient in nature and may or may not be visible to the remainder of the system.

Many microprocessor designs add hardware to help detect “soft errors” and correct the “soft errors” if possible in order to increase reliability. Various techniques have been employed to detect these “soft errors.” An example of such a technique is to add parity to memory structures. While these techniques are effective for protecting memory structures, these techniques are not very effective for protecting random control logic, execution datapaths, and latches within the integrated circuit from “soft errors.”

One prior art technique to protect random control logic and the corresponding execution datapaths is referred to as “lockstepped cores” or “Functional Redundancy Check.” This technique involves running two or more microprocessors in lock step. The two microprocessors operate as a master-checker pair. Since multiple microprocessors are executing the identical code, the same results are expected. When the results are compared and the results are not the same, a fault is raised. The results of the master microprocessor and a checker microprocessor are continuously compared. Although this technique is effective in detecting many soft errors, this solution is expensive in that multiple processing elements are required to perform the check.

Based on the foregoing, there remains a need for soft error detection method and system for processors that overcomes the disadvantages of the prior art as set forth previously.

### SUMMARY OF THE INVENTION

According to one embodiment of the present invention, a processor that includes an in-order execution architecture for executing at least two instructions per cycle (e.g., 2n instructions are processed per cycle, where n is an integer greater than or equal to one) and at least two symmetric execution units is described. The processor includes an instruction fetch unit for fetching n instructions (where n is an integer greater than or equal to one) and an instruction decoder for decoding the n instructions. The error detection mechanism includes duplication hardware for duplicating the n instructions into a first bundle of n instructions and a second bundle of n instructions. A first execution unit for executing the first bundle of instructions in a first execution cycle, and a second symmetric execution unit for executing the second bundle of instructions in the first execution cycle are provided. The error detection mechanism also includes comparison hardware for comparing the results of the first execution unit and the results of the second execution unit. The comparison hardware can have an exception unit for generating an exception (e.g., raising a fault) when the results are not the same. A commit unit is provided for committing one of the results when the results are the same.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1A illustrates an execution unit pipeline according to one embodiment of the present invention.

FIG. 1B illustrates a pipeline for a processor implementing the IA64 architecture in which the error detection mechanism of the invention can be implemented.

FIG. 2 is a block diagram illustrating the error detection mechanism in accordance with one embodiment of the present invention.

FIG. 3 is a flow chart illustrating the steps performed by the error detection mechanism of FIG. 2 in accordance with one embodiment of the present invention.

FIG. 4 is a block diagram illustrating in greater detail the duplication mechanism of FIG. 2 in accordance with one embodiment of the present invention.

FIG. 5 is a state diagram for the duplication mechanism of FIG. 4 in accordance with one embodiment of the present invention.

FIG. 6 is a block diagram illustrating in greater detail the comparison mechanism of FIG. 2 in accordance with one embodiment of the present invention.

FIG. 7 illustrates in greater detail the load handling mechanism in accordance with one embodiment of the present invention.

FIG. 8 illustrates in greater detail the store handling mechanism in accordance with one embodiment of the present invention.

FIG. 9 illustrates a control register for use in enabling the error detection mechanism in accordance with one embodiment of the present invention.

FIG. 10 illustrates an exemplary portion of software code that includes instructions to enable and disable the error detection mechanism in accordance with one embodiment of the present invention.

FIG. 11 illustrates a high-level block diagram of an IA-64 processor in which the error detection mechanism of the invention may be implemented according to one embodiment of the invention.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

The system and method for detecting soft error in microprocessors can be implemented in hardware, software, firmware, or a combination thereof. In one embodiment, the invention is implemented using hardware. In another embodiment, the invention is implemented using software that is executed by general purpose or an application specific processor.

A hardware implementation can include one or more of the following well-known technologies: discrete logic circuits that include logic gates for implementing logic functions upon data signals, application specific integrated circuit (ASIC), a programmable gate array(s) (PGA), and a field-programmable gate array (FPGA).

Execution Unit Pipeline 110

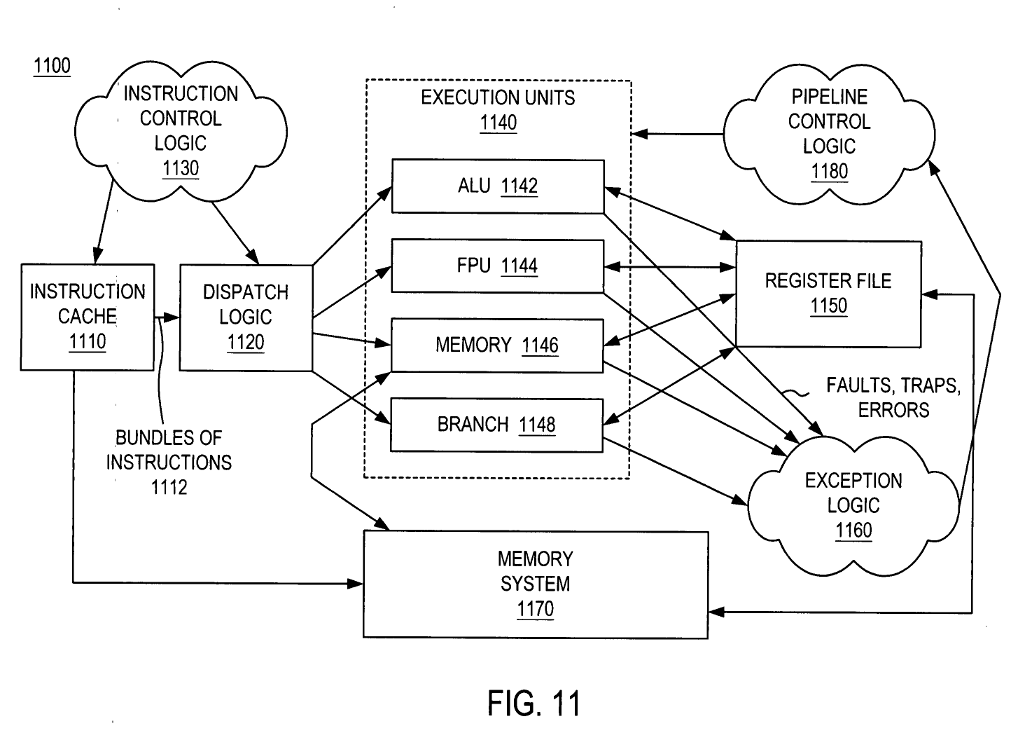

FIG. 11 illustrates a high-level block diagram of an IA-64 processor 1100 in which the error detection mechanism of the invention may be implemented according to one embodiment of the invention. FIG. 11 illustrates how instructions flow through the IA-64 processor 1100 and provides a context for the remaining figures.

Instructions are fetched from an instruction cache 1110 (which is connected to a memory 1170). Bundles of instructions 1112 flow from the instruction cache 1110 to dispatch logic 1120. Both the instruction cache 1110 and the dispatch logic 1120 are controlled by instruction control logic 1130. The dispatch logic 1120 then sends the various instructions to a variety of execution units 1140 (e.g., ALU 1142, FPU 1144, Memory Unit 1146, Branch Unit 1148) depending on the type of instruction and other rules.

All of the execution units 1140 receive and send values to a register file 1150. The memory unit 1146 also communicates with a memory subsystem 1170. All the execution units 1140 also communicate with exception logic 1160 (e.g., communicating faults and traps). For example, mechanisms that are known to those of ordinary skill in the art may be employed for signaling errors to the exception logic 1160. Pipeline control logic 1180, to which the exception logic 1160 provides information, further controls the IA-64 processor 1110. The error detection mechanism according to the invention detects soft errors and signals these errors to the exception logic 1160. The error detection mechanism according to the invention may be integrated into the dispatch logic 1120 and the various execution units as described in greater detail hereinafter.

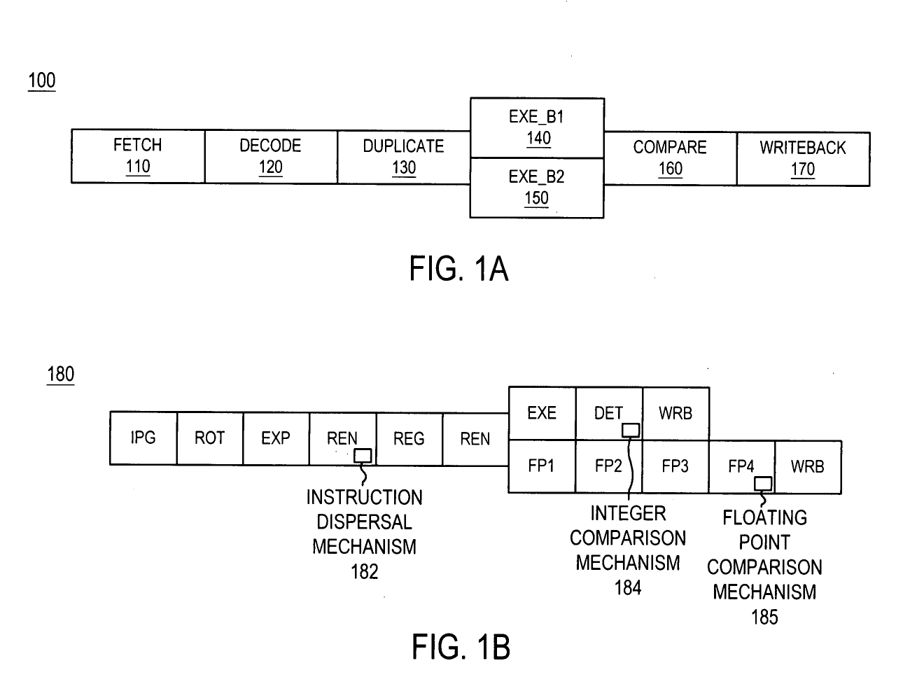

FIG. 1A illustrates an execution unit pipeline 100 according to one embodiment of the present invention. The execution unit pipeline 100 includes a fetch stage 10, a decode stage 120, a duplication stage 130, an execute first bundle (B1) stage 140, an execute second bundle (B2) stage 150 (that occurs in parallel), a comparison stage 160 and a commit stage 170. In the fetch stage 110, one or more instructions (e.g., n instructions, where n is equal to or greater than one) are fetched from memory (which may include an instruction cache). In the decode stage 120, the fetched instructions are decoded. In the duplication stage 130, the n instructions are duplicated.

In the execute first bundle (B1) stage 140, the first set of n instructions (e.g., the first bundle of n instructions) is executed by a first execution unit. In the execute second bundle (B2) stage 150, the duplicated set of n instructions (e.g., the second bundle of n instructions) is executed by a second execution unit that is symmetric with the first execution unit. Symmetric execution units have similar processing capabilities or identical processing capabilities.

In the comparison stage 160, the results of the first execution unit and the results of the second execution unit are compared. When the results are the same, the results of either the first execution unit or the results of the second execution unit are committed (e.g., written back to memory or a register file) in the commit stage (write-back stage) 170. The result from the other execution is discarded. When the results are not the same, a fault or exception is raised. The fault may be recoverable by flushing the instructions and re-executing the instructions in the commit stage 170 when the fault is detected before results are committed.

IA 64 Architecture

FIG. 1B illustrates a pipeline execution unit pipeline 180 for a processor implementing the IA-64 architecture in which the error detection mechanism of the invention can be implemented. The execution unit pipeline 180 includes the following stages:

IPG: Instruction Pointer Generate, Instruction address to the instruction cache.

ROT: Present two Instruction Bundles from the instruction cache to dispersal hardware.

EXP: Disperse up to 6 instruction syllables from the 2 instruction bundles.
The EXP stage of the pipeline can include an instruction dispersal mechanism 182 according to the invention for duplicating an instruction bundle. For example, in one embodiment, up to 3 instructions in the first bundle may be duplicated to generate a second bundle that is identical to the first bundle. The bundle and the copy of the bundle are then dispersed to the execution units instead of two different instructions bundles.

REN: Rename (or convert) virtual register IDs to physical register IDs.

REG: Register file read, or bypass results in flight as operands.

EXE: Execute integer instructions; generate results and predicates in multiple execution units.

DET: Detect exceptions, traps, etc.
The DET stage of the pipeline can include a comparison mechanism 184 according to the invention for comparing the results of a first integer execution unit and the results of a second integer execution unit.

FP1-4: Execute floating point instructions; generate results and predicates.
The FP4 stage of the pipeline can include a comparison mechanism 185 according to the invention for comparing the results of a first floating point execution unit and the results of a second floating point execution unit.

WRB: Write back results to the register file (architectural state update).

Error Detection Mechanism

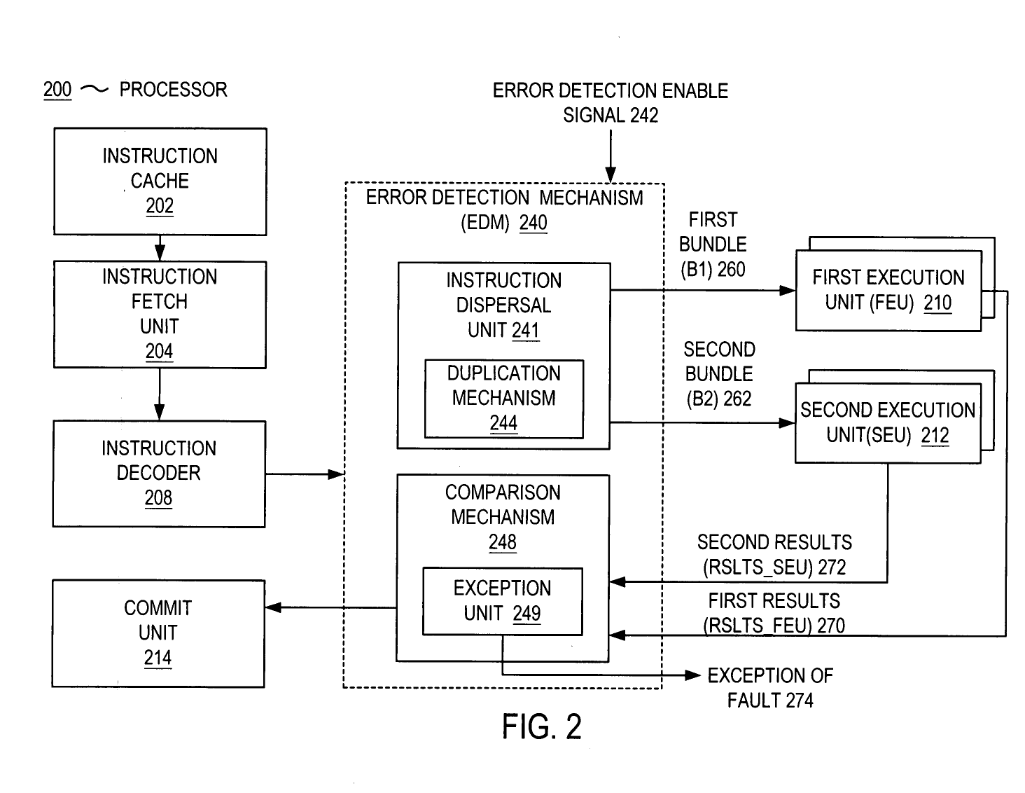

FIG. 2 is a block diagram illustrating a processor 200 that includes the error detection mechanism 240 in accordance with one embodiment of the present invention. The processor 200 includes an instruction fetch unit 204 for fetching an instruction from memory (e.g., an instruction cache 202) and an instruction decoder 208 for decoding the instruction.

The processor 200 also includes the error detection mechanism (EDM) 240 for detecting soft errors. The error detection mechanism 240 is selectively enabled by an error detection enable signal 242. The generation and control of the error detection enable (EDE) signal 242 are described in greater detail hereinafter. When enabled, the error detection mechanism 240 performs the duplication and comparison as described herein. When the error detection mechanism 240 is not enabled, the processor operates in the normal fashion without checking for soft errors.

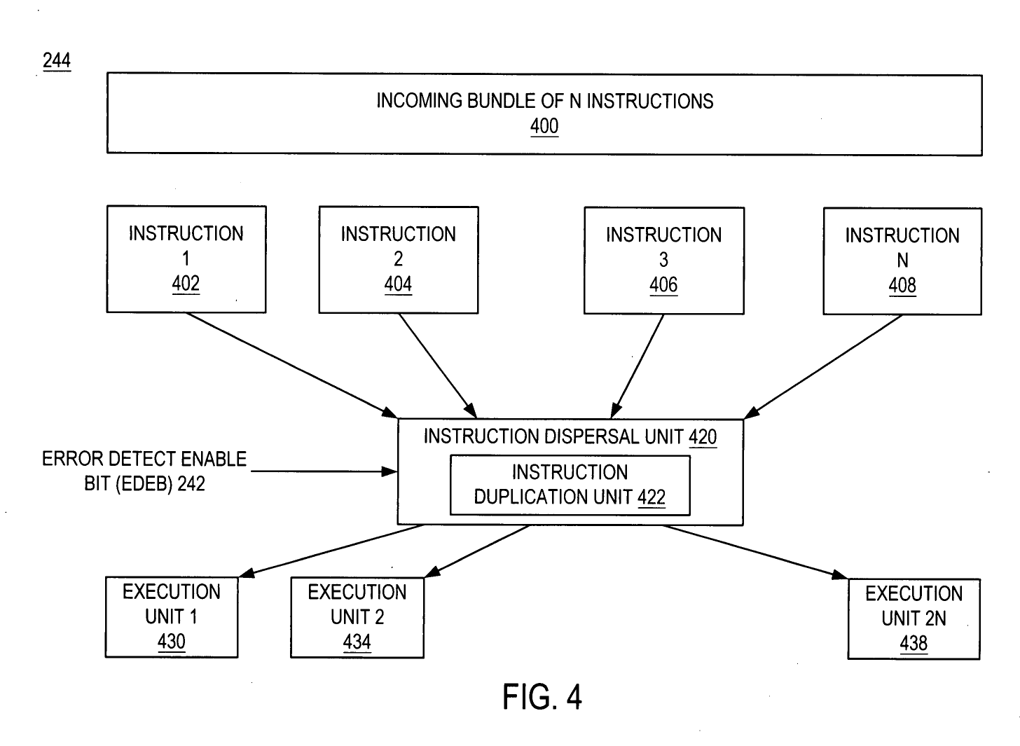

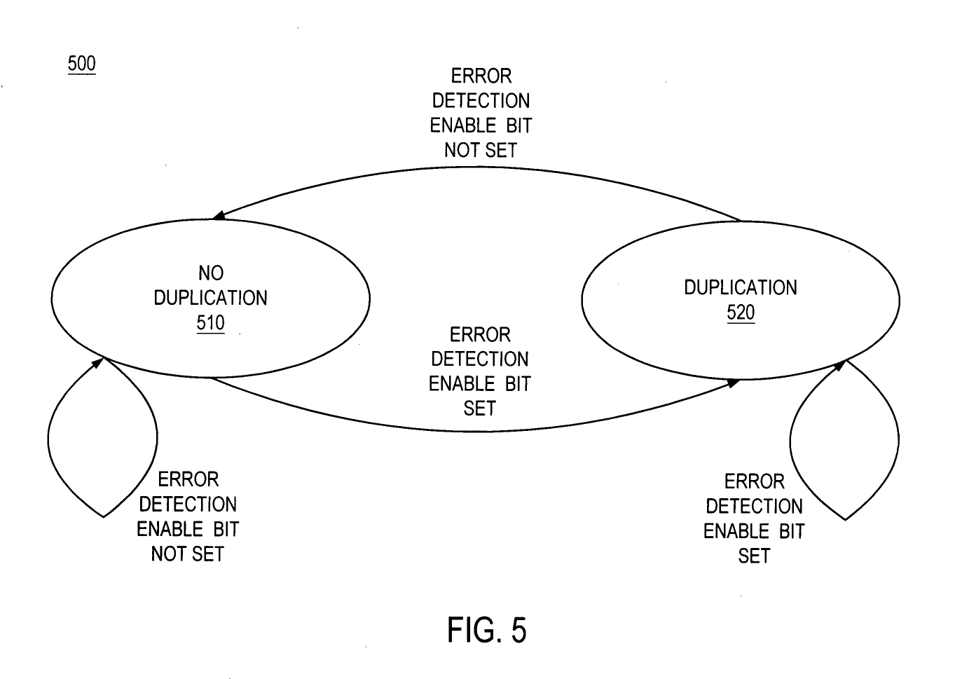

The error detection mechanism 240 includes an instruction dispersal unit 241 and a comparison mechanism 248. The instruction dispersal unit 241 includes a duplication mechanism 244 for duplicating instructions (e.g., generating a first bundle (B1) 260 of n instructions and a second bundle (B2) 262 of n identical instructions). An exemplary implementation of the duplication mechanism 244 is described in greater detail hereinafter with reference to FIGS. 4 and 5.

The processor 200 also includes at a first execution unit (FEU) 210 for executing the first bundle (B1) 260 of n instructions in a first execution cycle and a second execution unit (SEU) 212 for executing the second bundle (B2) 262 of n instructions in the first execution cycle.

The first execution unit (FEU) 210 and the second execution unit (SEU) 212 can include, but is not limited to, a floating point unit, an integer unit, an arithmetic logic unit (ALU), a multimedia unit, and a branch unit. It is noted that an implementation (microarchitecture) having an even number of execution units with similar or identical capabilities (hereinafter referred to as symmetric execution units) supports the error detection mechanism according to the invention.

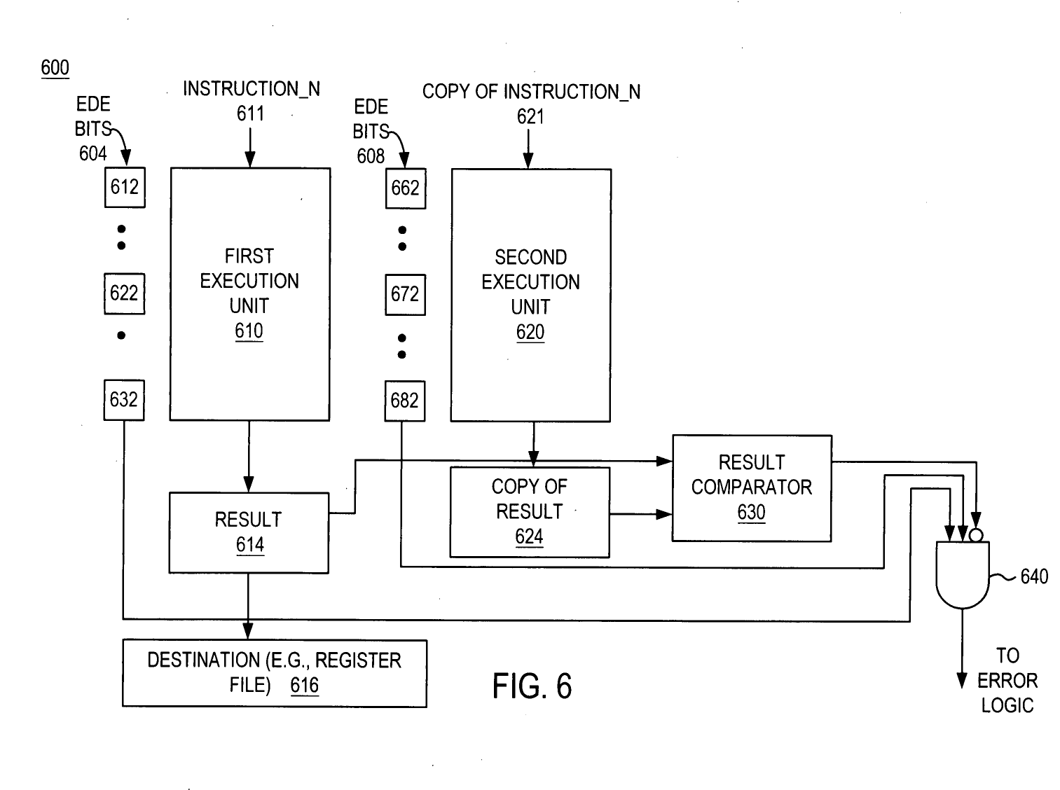

The error detection mechanism 240 also includes a comparison mechanism 248 for comparing the results of the first execution unit (results_FEU) 270 and the results of the second execution unit (results_SEU) 272. The comparison mechanism 248 includes an exception unit 249 for generating an exception 274 (e.g., raising a fault) when the results are not the same. An exemplary implementation of the comparison mechanism 248 is described in greater detail hereinafter with reference to FIG. 6.

The processor 200 also includes commit unit 214 for committing one of the results when the results of the first execution unit are the same as the results of the second execution unit.

### Processing Steps Performed by the Error Detection Mechanism 240

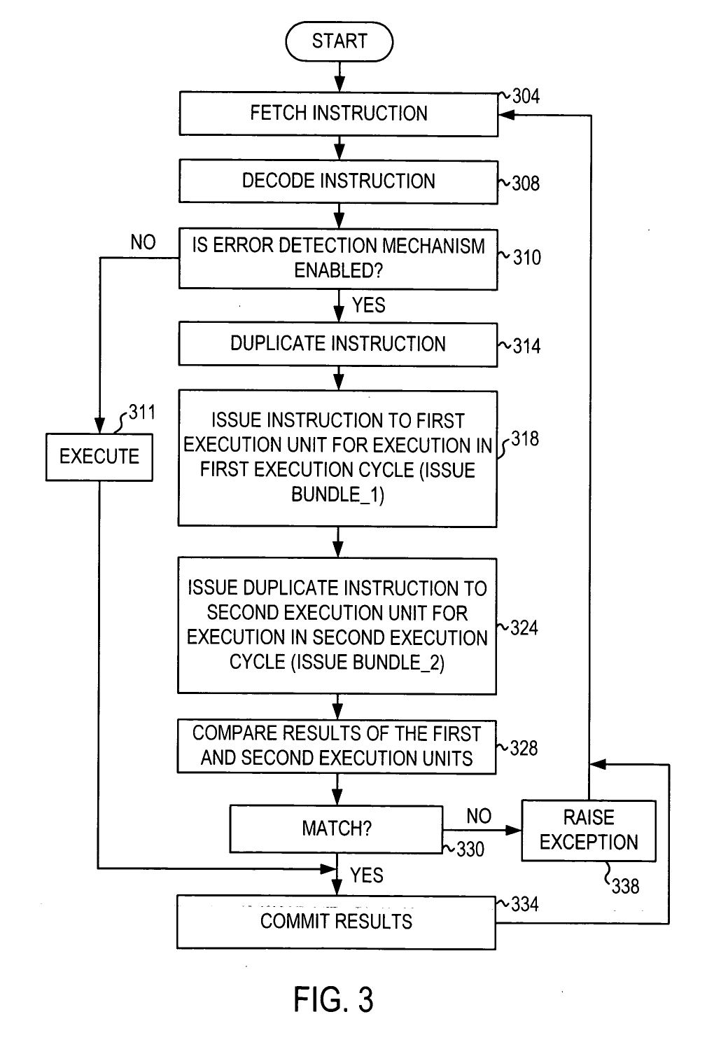

FIG. 3 is a flow chart illustrating the steps performed by the error detection mechanism of FIG. 2 in accordance with one embodiment of the present invention. In step 304, n instructions are fetched, where n is an integer equal to or greater than one. These n instructions are referred to herein as a bundle. In step 308, the n instructions are decoded. In decision block 310, a determination is made whether the error detection mechanism according to the invention is enabled. For example, the error detection mechanism may be enabled by asserting the error detection enable (EDE) signal 242. When the error detection mechanism is enabled, processing proceeds to step 314. Otherwise, when the error detection mechanism is not enabled, processing proceeds to step 311, where the instructions are executed.

In step 314, the n instructions are duplicated into a first bundle 260 of n instructions and a second bundle 262 of n instructions when error detection mechanism 240 is enabled.

In step 318, the first bundle 260 of n instructions is issued to a first execution unit 210 for execution in a first execution cycle. In step 324, the second bundle 262 of n instructions (e.g., duplicated instructions) is issued to the second execution unit 212 for execution in the first execution cycle. In this embodiment, the processor has an architecture that can execute two bundles of three instructions each per cycle. In this manner, the first bundle 260 of n instructions and the second bundle 262 of n instructions can be executed in parallel by two different sets but symmetric execution units. If a bundle contains more than one instruction, then the bundle is executed on more than one execution unit.

In step 328, the results 270 of the first execution unit and the results 272 of the second execution unit are compared. In decision block 330, a determination is made whether the results 270 of the first execution unit and the results 272 of the second execution match. When there is a match (i.e., the results are the same), in step 334, one of the results is committed (e.g., written back to memory or a register file). After results are committed, processing then proceeds to step 304 when more instructions are fetched.

In step 338, when there is no match (i.e., the results are not the same), an exception 274 is generated (e.g., a fault is raised). Processing then proceeds to step 304 when more instructions are fetched.

It is noted that theoretically the performance of the processor is cut in half by using the second bundle to redundantly execute the instructions in the first bundle instead of executing a different set of instructions. However, in practice, it is noted that the code executed by the processor cannot always take advantage of being able to issue two bundles every clock cycle. In these cases, a portion of the execution units is not utilized even in the non-lockstepped case. The error detection mechanism according to the invention utilizes these otherwise often non-utilized resources for checking and detecting soft errors. In this regard, the performance of the processor may be decreased. However, the performance loss is less than one-half the optimal performance since rarely is the pipeline run at the peak, optimal, or maximum rate of 2n instructions per cycle. The result is that reliability may be increased by checking for soft errors by employing the error detection mechanism according to the invention with a less-than expected loss in performance.

Duplication Mechanism

FIG. 4 is a block diagram illustrating in greater detail the duplication mechanism 244 of FIG. 2 in accordance with one embodiment of the present invention. The duplication mechanism 244 includes an instruction dispersal unit 420 for receiving a bundle of instructions 400 (e.g., instruction_1 402, instruction_2 404, instruction_3 406, . . . , instruction_N 408) and dispatching the instructions to a plurality of execution units (e.g., execution unit_1 430, execution unit_2 434, . . . , execution unit_2N 438). The instruction dispersal unit 420 includes an instruction duplication unit 422 for duplicating instructions. In the embodiment described with reference to FIG. 4, there is an even number of execution units (e.g., execution unit_1, execution unit_2, . . . , execution unit_2N), and each execution unit can execute all instructions. In some other embodiments, there may be an uneven number of execution units, or there may be certain instructions that can only be executed by a specific execution unit.

In these cases, where the execution units available to execute a particular instruction are not symmetric, the duplication mechanism according to the invention can perform the following processing. First, the duplication mechanism according to the invention can simply not duplicate a particular instruction. Second, the duplication mechanism according to the invention can simply duplicate instructions by utilizing only an even number of execution units while leaving the remaining execution idle. Third, the duplication mechanism according to the invention can employ all the execution units, but simply duplicate instructions assigned to a pair of execution units and not duplicate instructions assigned to a non-paired execution unit.

When an instruction is determined to be duplicatable and the error detection enable bit 242 is set, the instruction is duplicated and the compare bit that is described in greater detail hereinafter with reference to FIG. 6 is set. When an instruction is determined not to be duplicatable or the error detection enable bit is not set, the instruction is not duplicated and the compare bit is not set.

The term “duplicatable” as used herein refers to one of the following: 1) instructions that can be duplicated without undue effort and 2) the availability of an even number of execution units that can both execute a particular instruction. If either of the two above conditions cannot be satisfied, an instruction can be designated or denoted as “not duplicatable.”

In one embodiment, the instruction dispatch unit 420 dispatches instructions to the execution units (e.g., execution units 1, 2, . . . , 2n) in accordance with the algorithm set forth in TABLE I.

TABLE I

| EXECUTION UNIT | NON-DUPLICATE | DUPLICATE |
|---|---|---|
| 1 | 1 | 1 |
| 2 | 2 | 1 |
| 3 | 3 | 2 |
| 4 | 4 | 2 |
| 5 | 5 | 3 |
| 6 | 6 | 3 |
| . | . | . |
| . | . | . |
| . | . | . |
| n | n | : |
| . | . | . |
| . | . | . |
| . | . | n |
| . | . | . |
| 2n | 2n | n |

In another embodiment, the instruction dispatch unit 420 disperses 2n instructions to the eleven different execution units. The instruction dispatch unit 420 can include duplication hardware to generate two bundles of n identical instructions.

FIG. 5 is a state diagram for the duplication mechanism of FIG. 4 in accordance with one embodiment of the present invention. The state diagram 500 includes a first state 510 (referred to as NO DUPLICATION state) and a second state 520 (referred to as DUPLICATION state). The duplication mechanism 244 remains in the first state 510 when the error detection enable (EDE) bit 242 is not set (e.g., de-asserted). The duplication mechanism 244 transitions from the first state 510 to the second state 520 when the error detection enable (EDE) bit 242 is set (e.g., asserted). The duplication mechanism 244 remains in the second state 520 when the error detection enable (EDE) bit 242 is set (e.g., asserted). The duplication mechanism 244 transitions from the second state 520 to the first state 510 when the error detection enable (EDE) bit 242 is not set (e.g., de-asserted).

It is noted that the error detection enable (EDE) bit 242 can be provided by a configuration register or the instruction itself. The DUPLICATION state 520 is output to logic in the instruction dispatch unit 420 that controls duplication.

Comparison Mechanism

FIG. 6 is a block diagram illustrating in greater detail the comparison mechanism 600 of FIG. 2 in accordance with one embodiment of the present invention. The comparison mechanism 600 includes a plurality of error detect enable bits (also referred to herein as compare valid bits). For example, there can be an error detect enable bit for each instruction executed by each execution unit.

In this embodiment, the comparison mechanism 600 includes a plurality of bits 604 associated with a first execution unit 610 and a plurality of bits 608 associated with the second execution unit 620.

The first plurality of bits 604 can include a first compare valid bit 612 that is associated with a first instruction, a second compare valid bit 622 that is associated with a second instruction, and an N^{th} compare valid bit 632 is associated with an N^{th} instruction. It is noted that the first instruction, the second instruction, and the N^{th} instruction are executed by the first execution unit 610.

The second plurality of bits 608 can include a first compare valid bit 662 that is associated with a first instruction, a second compare valid bit 672 that is associated with a second instruction, and an N^{th} compare valid bit 682 is associated with an N^{th} instruction. It is noted that the first instruction, the second instruction, and the third instruction are executed by the second execution unit 620.

The first execution unit 610 executes instruction N 611 and generates a result 614. The second execution unit 620 executes a copy of instruction N 621 and generates a copy 624 of the result. The comparison mechanism also includes a result comparator 630 for receiving the result 614 and the copy 624 of the result, comparing the results (614 and 624) and generating a signal that indicates whether the results are the same.

The result comparator 630 can be implemented with OR gates or NOR gates. For example, when the results (614 and 624) are the same, the output of the comparator 630 can be asserted (e.g., a logic high).

The comparison mechanism 600 also includes an AND gate 640 that includes a first input for receiving compare valid bits associated with the first execution unit 610, a second input for receiving compare valid bits associated with the second execution unit 620 and a third inverted input for receiving the output of the comparator 630. The output of the AND gate 640 generates an error signal that is provided to error logic. It is noted that the error signal is asserted only when one or both comparison mechanisms are enabled and there is a mismatch or discrepancy in results of the execution units.

The compare valid bits enable the comparison mechanisms according to the invention to compare the results of two or more execution units.

In another embodiment, the compare valid bits are provided for only the first execution unit. In this embodiment, there is a compare valid bit for each instruction executing on the first instruction unit, but there is no separate compare valid bit for the copy of the instruction executing on the second instruction unit.

The result 614 is then provided to a destination 616 (e.g., register file, etc.).

When the units are not symmetric, a particular instruction may not be duplicated. For example, consider two integer execution units I0 and I1; one is capable of executing an instruction of type A; the other is not capable of executing instruction of type A. In this case, this instruction, A, is not duplicated on both instruction units, and the comparison enable bit traveling along I0 is not set according to the invention. Since the number of instructions that are not symmetric is very small, the processor is able to protect most instructions with this method.

Selectively Checking a Portion of Software Code for Soft Errors

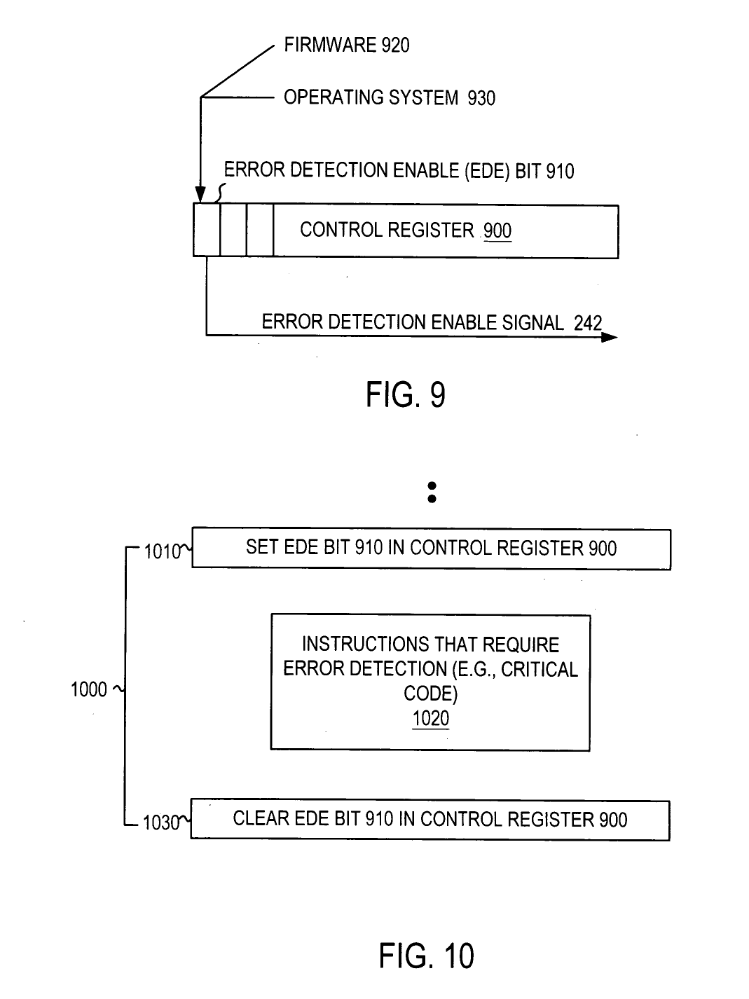

It is noted that the error detect enable bit 242 may be set or cleared by an operating system or by user-programmed firmware. In this manner, only a portion of the software code (e.g., a mission critical portion) can be selected for functional redundancy check. The error detect enable bit in the control register provides the ability and flexibility to have the error detection mechanism selectively enabled and disabled, thereby allowing a programmer to balance performance of the processor with the detection of soft errors. This mechanism for selectively enabling and disabling the error detection mechanism according to the invention is described in greater detail hereinafter with reference to FIGS. 9 and 10.

Handling Memory Operations

The error detection mechanism according to the invention provides special handling hardware for operations directed to a memory system (e.g., a cache). Specifically, the handling hardware includes hardware to handle load operations and hardware to handle store operations.

For load operations, the address of the first load operation and the address of the second load operation are compared. When there is a match, the first load operation is executed. When there is no match, an exception is raised. In one embodiment, hardware is provided to ensure that the first load is executed, but the second load is not executed. Since time needed for memory operations is a major factor in computing latency and determining processor performance, by ensuring that load operations are performed only once, the performance of the processor is increased.

Load Handling Mechanism

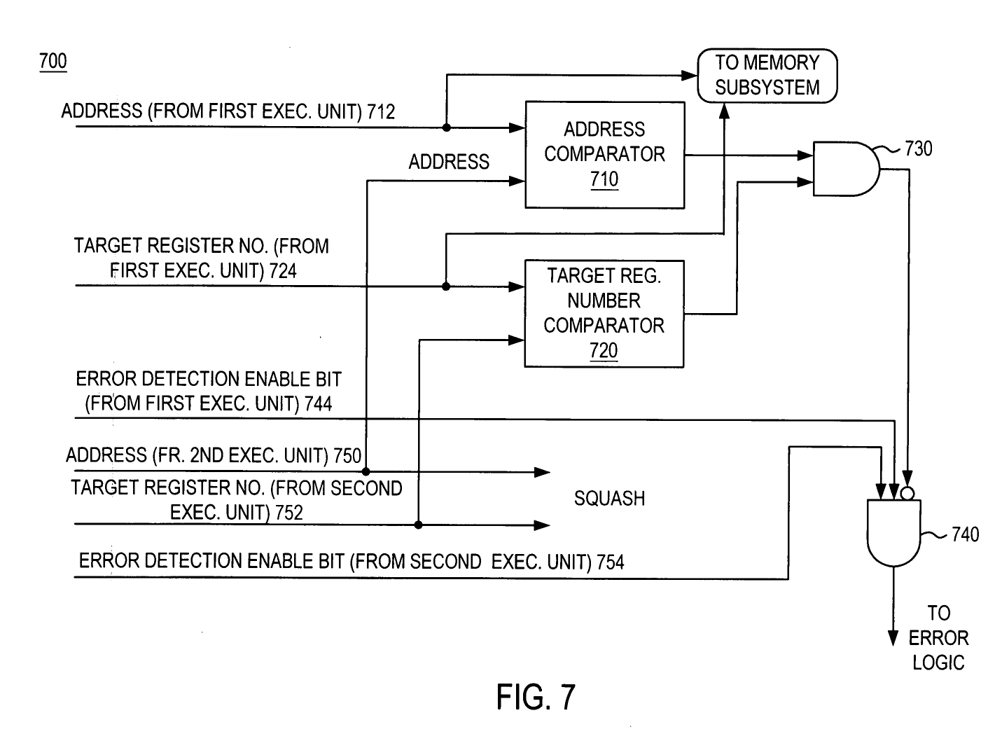

FIG. 7 illustrates in greater detail the load handling mechanism 700. The load handling mechanism 700 includes an address comparator 710 for comparing a first address 712 from a first execution unit and a second address 750 from a second execution unit. The load handling mechanism 700 also includes a target register number comparator 720 for comparing a first target register number 724 from the first execution unit and a second target register number 752 from the second execution unit.

The load handling mechanism 700 also includes a first AND gate 730 and second AND gate 740. The first AND gate 730 includes a first input for receiving the output of the address comparator 710, a second input for receiving the output of the target register bit comparator 720, and an output for generating an output signal.

The second AND gate 740 includes a first input for receiving a first compare enable signal 744 (e.g., an error detection enable signal) from the first execution unit, a second input for receiving a second compare enable signal 754 (e.g., an error detection enable signal) from the second, a third inverted input for receiving the output signal from the first AND gate 730, and an output for generating an error signal. For example, an asserted error signal can indicate that an error has been detected. The error signal 766 can be provided to error logic. The first and second compare enable signals can be, for example, the error detection enable signal 242.

The first address 712 and the first target register 724 are provided to a memory subsystem. It is noted that the second load (e.g., the address and target register number from the second execution unit) is squashed according to the invention unless the memory subsystem is designed and configured to handle a second load (e.g., to detect and to discard a second load). For example, the address 750 and the target register bit 752 from the second execution unit can be discarded by the load handling mechanism 700 according to the invention.

Alternatively, the address 712 and the target register bit 724 from the first execution unit can be discarded (i.e., squashed), and the address 750 and target register 752 received from the second execution unit can be provided to the memory. In this alternative embodiment, the logic shown in FIG. 7 may be modified or changed according to the invention to perform achieve the above-noted logical function.

Store Handling Mechanism

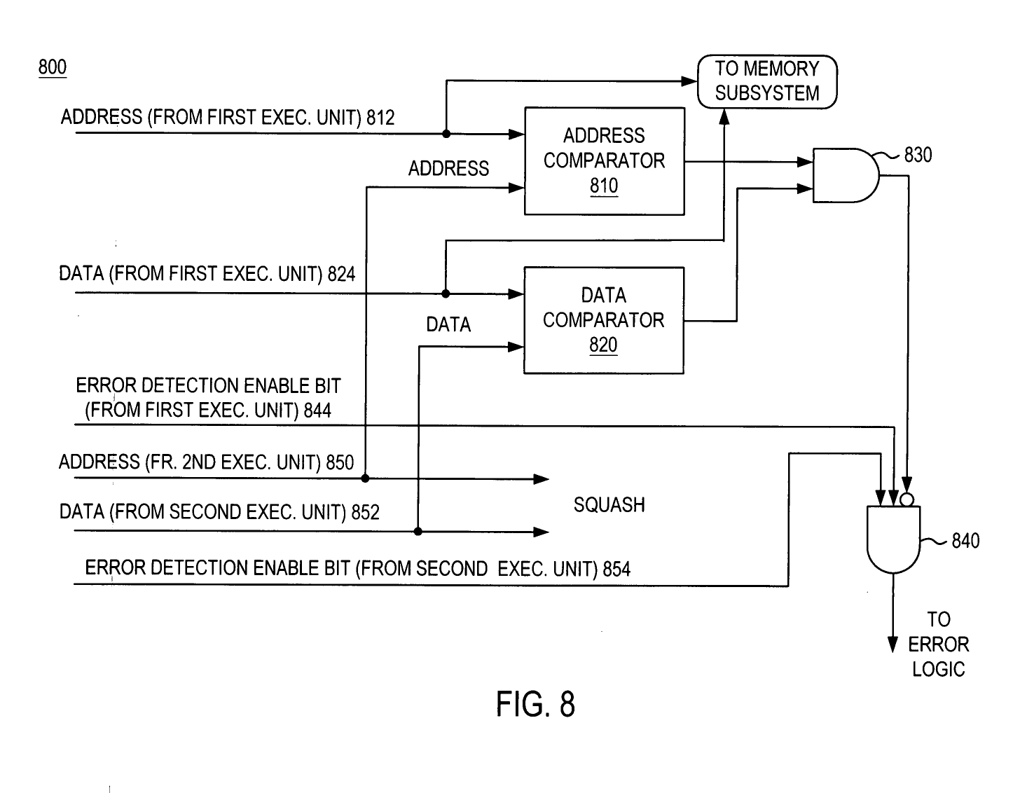

FIG. 8 illustrates in greater detail the store handling mechanism 800. The store handling mechanism 800 includes an address comparator 810 for comparing a first address 812 from a first execution unit and a second address 850 from a second execution unit. The store handling mechanism 800 also includes a data comparator 820 for comparing a data 824 from the first execution unit and data 852 from the second execution unit.

The store handling mechanism 800 also includes a first AND gate 830 and second AND gate 840. The first AND gate 830 includes a first input for receiving the output of the address comparator 810, a second input for receiving the output of the data comparator 820, and an output for generating an output signal.

The second AND gate 840 includes a first input for receiving a first compare enable signal 844 (e.g., an error detection enable signal) from the first execution unit, a second input for receiving a second compare enable signal 854 (e.g., an error detection enable signal) from the second execution unit, a third inverted input for receiving the output signal from the first AND gate 830, and an output for generating an error signal. For example, an asserted error signal can indicate that an error has been detected. The error signal can be provided to error logic. The first and second compare enable signals can be, for example, the error detection enable signal 242.

The address and the data from the first execution unit are provided to a memory subsystem. It is noted that the second store (e.g., the address and data from the second execution unit) is squashed according to the invention unless the memory subsystem is designed and configured to handle a second store (e.g., to detect and to discard a second store). For example, the address and the data can be discarded by the store handling mechanism 800 according to the invention. It is noted that in an alternative embodiment the first store can be squashed and the second store allowed to execute. In this embodiment, the logic to detect an error can be modified to accommodate such an embodiment.

### Error Detection Enable (EDE) Bit in a Control Register for Selectively Enabling the Error Detection Mechanism

FIG. 9 illustrates a control register 900 for use in enabling the error detection mechanism in accordance with one embodiment of the present invention. The control register 900 includes an error detection enable (EDE) bit 910. The error detection enable (EDE) bit 910 may be set and cleared by firmware 920 (e.g., user programmed firmware), by the operating system (OS) 930, or by an application 940. The error detection enable (EDE) bit 910 can utilized to provide the error detection signal 242 that selectively enables the error detection mechanism of the invention.

Prior art approaches to functional redundancy checking (FRC) do not provide the user the ability to selectively turn the FRC on or off. One novel aspect of the invention is the provision of a mechanism for allowing a user through firmware, the operating system (OS), or an application to selectively enable and disable the error detection mechanism of the invention. For example, a programmer can designate only certain portion of code to be subject to the error detection and checking and designate other portions of code to be processed without checking for soft errors.

FIG. 10 illustrates an exemplary portion 1000 of software code that includes instructions to enable and disable the error detection mechanism in accordance with one embodiment of the present invention. The portion 1000 includes a first instruction or firmware or operating system call 1010 for setting the EDE bit 910 in the control register 900 and a second instruction or firmware or operating system call 1030 for clearing the EDE bit 910 in the control register 900. Once the EDE bit 910 is set, the error detection mechanism of the invention is enabled to detect soft errors in critical code 1020. The software code prior to instruction 1010 and the code subsequent to instruction 1030 are not subject to error detection by the error detection mechanism of the invention. In this manner, the error detection mechanism of the invention can be selectively enabled to only check certain portions of code, thereby allowing a programmer to balance processor performance and reliability for mission critical portions of code.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

1. A processor that includes an in-order execution architecture for executing at least two instructions per cycle and at least two symmetric execution units comprising:
a) instruction fetch unit for fetching n instructions;
b) an instruction decoder for decoding the n instruction;
wherein 2n instructions are processed per cycle
c) duplication hardware for duplicating the n instructions into a first bundle and a second bundle; wherein each bundle includes n instructions;
d) a first execution unit for executing the first bundle of instructions in a first execution cycle;
e) the second symmetric execution unit for executing the second bundle of instructions in the first execution cycle;
f) comparison hardware for comparing the results of the first execution unit and the results of the second execution unit; and
g) a commit unit for committing one of the results when the results are the same; and
h) an exception unit for generating an exception (raising a fault) when the results are not the same.

2. The processor of claim 1
wherein the first execution unit issues the first bundle of instructions to the first execution unit; and
wherein the second symmetric execution unit issues the second bundle of instructions to the second execution unit in the first execution cycle.

3. The processor of claim 2
wherein the first execution unit is one of floating point unit, an integer unit, a arithmetic logic unit (ALU), a multimedia unit, and a branch unit; and
wherein the second execution unit is symmetric with respect to the first execution unit and includes one of floating point unit, an integer unit, a arithmetic logic unit (ALU), a multimedia unit, and a branch unit.

4. The processor of claim 1 wherein duplication hardware is provided for performing the instruction duplication and comparison hardware is provided for performing the comparison, the method further comprising the step of:
setting a bit in a control register;
wherein the bit enables the duplication hardware and comparison hardware.

5. The processor of claim 4 wherein the bit is set by one of user-programmed firmware, an operating system (OS), and an application.

6. The processor of claim 1 wherein n is equal to 3.

7. A method for detecting errors in a processor that executes 2n instructions per cycle comprising the steps of:
a) fetching n instructions; wherein n is an integer greater than 0;
b) decoding the n instructions;
c) duplicating the n decoded instructions into a first bundle of n decoded instructions and a second bundle of n decoded instructions;
d) employing a first execution unit to execute the first bundle of instructions in a first execution cycle;
e) employing a second symmetric execution unit for executing the second bundle of instructions in the first execution cycle;
f) comparing the results of the first execution unit and the results of the second execution unit;
g) when the results are the same, committing one of the results; and
h) when the results are not the same, generating an exception (raising a fault).

8. The method of claim 7
wherein the step of employing a first execution unit to execute the first bundle of instructions in a first execution cycle includes issuing the first bundle of instructions to the first execution unit; and
wherein the step of employing a second symmetric execution unit for executing the second bundle of instructions in the first execution cycle includes issuing the second bundle of instructions to the second execution unit.

9. The method of claim 7
wherein the first execution unit is one of floating point unit, an integer unit, a arithmetic logic unit (ALU), a multimedia unit, and a branch unit; and
wherein the second execution unit is symmetric with respect to the first execution unit and one of floating point unit, an integer unit, a arithmetic logic unit (ALU), a multimedia unit, and a branch unit.

10. The method of claim 7 wherein duplication hardware is provided for performing the instruction duplication and comparison hardware is provided for performing the comparison, the method further comprising the step of:
setting a bit in a control register;
wherein the bit enables the duplication hardware and comparison hardware.

11. The method of claim 10 wherein the bit is set by one of user-programmed firmware, an operating. system (OS), and an application.

12. (canceled).

13. The method of claim 7 wherein n is equal to 3.

14. A method for selectively enabling an error detection mechanism comprising the steps of:
a) maintaining a control register that includes an error detection enable bit;
b) setting the error detection enable bit to enable the error detection mechanism; and
c) clearing the error detection enable bit to disable the error detection mechanism.

15. The method of claim 14 wherein the step of setting the error detection enable bit to enable the error detection mechanism includes one of
a user-programmed firmware setting the error detection enable bit to enable the error detection mechanism;
an operating system setting the error detection enable bit to enable the error detection mechanism; and
an application setting the error detection enable bit to enable the error detection mechanism; and
wherein the step of clearing the error detection enable bit to disable the error detection mechanism includes one of
a user-programmed firmware clearing the error detection enable bit to enable the error detection mechanism;
an operating system setting clearing the error detection enable bit to enable the error detection mechanism; and
an application clearing the error detection enable bit to enable the error detection mechanism.

16. The method of claim 14 wherein the error detection mechanism is enabled for a portion of critical code that includes a first instruction and a last instruction;
wherein the step of setting the error detection enable bit to enable the error detection mechanism includes the step of
setting the error detection enable bit to enable the error detection mechanism prior to the execution of the first instruction of the critical portion of code; and
wherein clearing the error detection enable bit to disable the error detection mechanism includes
clearing the error detection enable bit to disable the error detection mechanism after the execution of the last instruction of the critical portion of code.

17. An apparatus for executing instructions comprising:
a) a control register that includes an error detection enable bit;
b) an error detection mechanism for detecting soft errors; and
c) a mechanism for selectively enabling the error detection mechanism by
setting the error detection enable bit to enable the error detection mechanism and by clearing the error detection enable bit to disable the error detection mechanism.

18. The apparatus of claim 17 wherein the selective enabling mechanism is one of a user-programmed firmware, an operating system, and an application.

19. The apparatus of claim 17 wherein the error detection mechanism is enabled for a portion of critical code that includes a first instruction and a last instruction;
wherein the selective enabling mechanism sets the error detection enable bit to enable the error detection mechanism prior to the execution of the first instruction of the critical portion of code; and
wherein the selective enabling mechanism clears the error detection enable bit to disable the error detection mechanism after the execution of the last instruction of the critical portion of code.
